(19) United States
(12) Patent Application Publication
(10) Pub. No.: US 2023/0142107 A1
(43) Pub. Date: May 11, 2023

(54) DATA PIPELINE MANAGEMENT IN OPERATIONAL TECHNOLOGY HARDWARE AND NETWORKS

(71) Applicant: Dragos, Inc., Hanover, MD (US)

(72) Inventor: GARRETT BLADOW, Baltimore, MD (US)

(73) Assignee: Dragos, Inc., Hanover, MD (US)

(21) Appl. No.: 17/520,591

(22) Filed: Nov. 5, 2021

(51) Int. Cl. G06F 16/25; G06F 16/26

(52) U.S. Cl. CPC G06F 16/252; G06F 16/254; G06F 16/26

(57) ABSTRACT

On an operational technology network device, a first environment and a second environment are created and isolated. A first set of data pipelines are executed in the first environment that ingest a first set of data from a first set of data sources. A second set of data pipelines are executed in the second environment that ingest a second set of data from a second set of data sources. A first set of data management applications are executed in the first environment that access the first set of data and are isolated from the second set of data. A second set of data management applications are executed in the second environment that access the second set of data and are isolated from the first set of data. Execution of the first set of data pipelines is prioritized over execution of the second set of data pipelines.

### FIELD OF THE DISCLOSURE

The present disclosure generally relates to operational technology networks, and relates more specifically to data collection in operational technology networks.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Operational technology (OT) refers to hardware and software systems that are used to monitor and control physical processes, devices, and infrastructure. OT includes industrial control systems. Industrial control systems are configured to monitor and control industrial processes in areas such as oil, gas, manufacturing, building automation, mining operations, electricity generation/distribution, other utilities, transportation, pharmaceutical, and the like. As OT systems become more connected, they are exposed to more vulnerabilities. Security threats can cause major disruptions to OT environments that can damage expensive equipment and infrastructure, and can be costly to remediate.

In the course of normal operation, an OT network generates a large quantity of data that is usable to monitor the OT network. Data pipeline architecture is the design of systems for capturing, transforming, and routing data in a scalable, automated manner. An organization may create its own data pipelines from scratch, or use existing frameworks to develop data pipelines. Developing data pipelines in an existing framework, such as Amazon OpenSearch Service /Elasticsearch, requires a high level of expertise with the framework. Incorporating OT data sources into a data pipeline also requires specialized knowledge of OT-specific protocols, hardware, and/or software. Developers must write new code for every data source, and may need to rewrite the code if a vendor makes changes to the hardware or software. Furthermore, the execution of data pipelines may also affect the operation of devices in the OT network.

### SUMMARY

The appended claims may serve as a summary.

### BRIEF DESCRIPTION OF THE DRAWINGS

In the drawings:

FIG. 1 illustrates a computer network that includes a data pipeline management system in an example embodiment;

FIG. 2 illustrates a computer network that includes one or more hardware devices deployed in an operational technology (OT) network in an example embodiment;

FIG. 3 is a flow diagram of a process for data pipeline management in an example embodiment;

FIG. 4 is a flow diagram of a process for facilitating user creation of a pipeline using templates in an example embodiment;

FIG. 5 illustrates a computer system upon which an embodiment may be implemented.

While each of the drawing figures illustrates a particular embodiment for purposes of illustrating a clear example, other embodiments may omit, add to, reorder, or modify any of the elements shown in the drawing figures. For purposes of illustrating clear examples, one or more figures may be described with reference to one or more other figures. However, using the particular arrangement illustrated in one or more other figures is not required in other embodiments.

### DETAILED DESCRIPTION

In the following description, numerous specific details are set forth in order to provide a thorough understanding of the present invention. It will be apparent, however, that the present invention may be practiced without these specific details. The detailed description that follows describes exemplary embodiments and the features disclosed are not intended to be limited to the expressly disclosed combination(s). Therefore, unless otherwise noted, features disclosed herein may be combined to form additional combinations that were not otherwise shown for purposes of brevity.

It will be understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and does not imply an ordering, timing, or any other characteristic of the referenced items unless otherwise specified; the term “and/or” as used herein refers to and encompasses any and all possible combinations of one or more of the associated listed items; that the terms “comprises” and/or “comprising” specify the presence of stated features, but do not preclude the presence or addition of one or more other features.

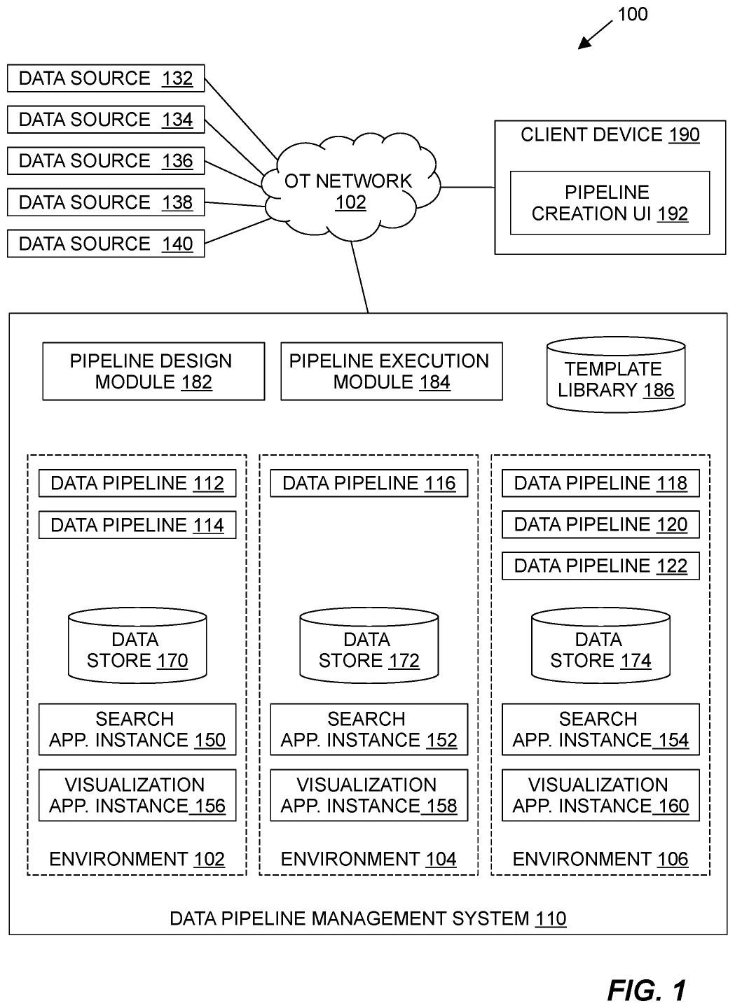

A “module” may be hardware, and/or software stored in, or coupled to, a memory and/or one or more processors on one or more computers. As an addition or alternative, a module may comprise specialized circuitry. For example, a module (such as but not limited to pipeline design module 182 and execution module 184 of FIG. 1) may be hardwired and/or persistently programmed with a set of instructions to perform the functions discussed herein. A module may be a standalone module, work in conjunction with one or more other modules, contain one or more other modules, and/or belong to one or more other modules.

A “computer system” refers to one or more computers, such as one or more physical computers, virtual computers, and/or computing devices. For example, a computer system may be, or may include, one or more server computers, desktop computers, laptop computers, mobile devices, special-purpose computing devices with a processor, cloud-based computers, cloud-based cluster of computers, virtual machine instances, and/or other computing devices. A computer system may include another computer system, and a computing device may belong to two or more computer systems. Any reference to a “computer system” may mean one or more computers, unless expressly stated otherwise. When a computer system performs an action, the action is performed by one or more computers of the computer system.

A “device” may be a computer system, hardware, and/or software stored in, or coupled to, a memory and/or one or more processors on one or more computers. As an addition or alternative, a device may comprise specialized circuitry. For example, a device may be hardwired or persistently programmed to support a set of instructions to perform the functions discussed herein. A device may be a standalone component, work in conjunction with one or more other devices, contain one or more other devices, and/or belong to one or more other devices.

A “client” refers to a combination of integrated software components and an allocation of computational resources, such as memory, a computing device, and/or processes on a computing device for executing the integrated software components. The combination of the software and computational resources are configured to interact with one or more servers over a network, such as the Internet. A client may refer to either the combination of components on one or more computers, or the one or more computers (also referred to as “client computing devices”).

A “server” refers to a combination of integrated software components and an allocation of computational resources, such as memory, a computing device, and/or processes on the computing device for executing the integrated software components. A server provides one or more services to one or more other programs and/or computers. The combination of the software and computational resources is dedicated to providing a particular type of function on behalf of clients of the server. A server may refer to either the combination of components on one or more computing devices, or the one or more computing devices (also referred to as “server system”). A server system may include multiple servers; that is, a server system may include a first computing device and a second computing device, which may provide the same or different functionality to the same or different set of clients.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage objects, such as CD or DVD objects, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. As an addition or alternative, embodiments may be implemented in the form of computer-programs, or a computer-usable carrier medium capable of carrying such a program.

### General Overview

This document generally describes systems, methods, devices, and other techniques for data pipeline management in operational technology (OT) networks and/or OT hardware. In some implementations, a data pipeline management system creates a first environment and a second environment that are isolated. In some embodiments, the data pipeline management system is deployed on an OT network device. The data pipeline management system executes, in the first environment, a first set of one or more data pipelines that ingest a first set of data from a first set of data sources deployed in an OT network. The data pipeline management system executes, in the second environment, a second set of one or more data pipelines that ingest a second set of data from a second set of data sources deployed in the OT network. The data pipeline management system may create one or more additional environments for the execution of additional sets of data pipelines in an isolated environment.

The data pipeline management system prioritizes execution of the first set of data pipelines over execution of the second set of data pipelines. In some embodiments, the first set of data pipelines includes one or more data pipelines that are designed by an authorized party, and the second set of data pipelines includes one or more data pipelines that are designed by an end user of the data pipeline management system. In some embodiments, the data pipeline management system creates a third environment and executes, in the third environment, a third set of data pipelines ingest a third set of data from a third set of data sources. The data pipeline management system may prioritize execution of the third set of data pipelines after execution of the second set of data pipelines and execution of the first set of data pipelines. In some embodiments, the third set of data pipelines may include one or more data pipelines that are designed by an approved third party.

The data pipeline management system may execute a first set of one or more data management applications in the first environment and a second set of one or more data management applications in the second environment. For example, the data pipeline management system may execute, in a particular environment, a search application for searching a set of data belonging to the particular environment. As another example, the data pipeline management system may execute, in a particular environment, a visualization application for manipulating and presenting the set of data belonging to the particular environment.

In some embodiments, the data pipelines include one or more Logstash pipelines. For example, the data pipeline management system may execute one or more Logstash instances that execute one or more Log stash pipelines within an environment. In some embodiments, the data management applications include one or more Elasticsearch instances and/or Kibana instances. Data management applications executing in one environment are isolated from applications, data pipelines, and/or data belonging to another environment. In some embodiments, the data pipeline management system priorities execution of the first set of data management applications over execution of the second set of data management applications.

A data pipeline management system may include a pipeline design module that enables an end user to create data pipelines in an OT network without needing specialized technical expertise. For example, the pipeline design module may enable a user to design and manage data pipelines without specialized technical expertise about an underlying data pipeline framework, specific OT data sources, specific OT destinations, specific OT network protocols, and/or other specialized technical knowledge.

In some embodiments, the data pipeline management system maintains a template library. The template library may include a plurality of pipeline component templates that are usable to implement data pipelines specific to one or more OT data sources, OT destinations, and/or OT network protocols. In some implementations, the plurality of pipeline component templates includes at least one extract template, at least one transform template, and at least one load template. The data pipeline management system may provide a pipeline creation UI to a client device. Through the pipeline creation UI, the data pipeline management system accepts user input including a selected set of pipeline component templates and user input including a set of attribute values required by the selected set of pipeline component templates. The data pipeline management system executes a data pipeline based on the selected set of pipeline component templates and the set of attribute values.

In some implementations, the various techniques described herein may achieve one or more of the following advantages: end users can customize the flow of data in their OT environment; the expertise required to create and execute data pipelines is reduced; developers can use and create templates for working with data pipelines in a simplified framework; reuse of data pipeline code is enabled; an OT device can ship with data pipeline functionality developed by an authorized party such as a manufacturer of the OT device, functionality developed by an approved third party such as an affiliate, and/or data pipeline design functionality that enables an end user to create data pipelines without specialized technical expertise; execution of data pipelines and/or data management applications in isolated environments protects the integrity, availability, and/or confidentiality of data and data management applications; execution of data pipelines and/or data management applications in isolated environments increases security of the OT network. Additional features and advantages are apparent from the specification and the drawings.

### System Overview

FIG. 1 illustrates a computer network that includes a data pipeline management system in an example embodiment. The computer network 100 includes a plurality of devices connected in an OT network 102. A device that is connected to an OT network 102 is also referred to herein as an OT network device. The computer network 100 includes OT network devices such as but not limited to a plurality of data sources 132-140, a data pipeline management system 110, and a client device 190. In some embodiments, the data pipeline management system 110 is deployed on an OT network device.

The data pipeline management system 110 provides data pipeline functionality within an OT network 102. In some embodiments, the data pipeline management system 110 includes a pipeline execution module 184 that is configured to manage data pipeline execution in isolated environments 102-106. As an addition or alternative, the data pipeline management system 110 includes a pipeline design module 182 that is configured to provide a pipeline creation UI 192 to a client device 190 for designing data pipelines using a template library 186 that includes pipeline component templates. The pipeline design module 182 and the execution module 184 may include separate and/or shared processes. The pipeline design module 182 and the execution module 184 may execute as one or multiple applications on one or more computer systems, and may be implemented in a distributed system architecture, a cloud system architecture, and/or a virtual system.

A data pipeline 112-122 is a set of procedures for processing data, such as but not limited to ingesting/collecting raw data from one or more data sources 132-140, transforming data, validating data, extracting data, combining data, loading data (e.g., for storage, analysis, visualization, etc.), transmitting data to a destination, and/or otherwise processing data. A data pipeline 112-122 may process data in real time as the data is generated by a data source 132-140. As an alternative or addition, one or more data pipelines 112-122 may process data in near-real time or in batches. A data pipeline 112-122 may automate aspects of data processing in a scalable manner.

In the OT network 102, a data source 132-140 may include software and/or hardware that stores and/or generates data, such as but not limited to databases, files, applications, services, feeds, network appliances, and other sources of data. Common data sources in an OT network 102 include sensors, other physical process devices, supervisory control and data acquisition (SCADA) systems, human-machine interfaces (HMIs), master terminal units (MTUs), other control system devices, historian devices, monitoring devices, other operation system devices, networking devices, monitoring devices, alarm and alert systems, control room workstations, and/or any combination thereof. A data source 132-140 may also include software executing on such devices, databases, log files, and/or other files generated during the operation of such devices. A destination includes anything that receives data via a data pipeline 112-122, such as a database, application, service, other software, OT network device, other hardware, and/or other destination.

In some embodiments, a data pipeline 132-140 ingests telemetry data from one or more data sources 132-140 deployed in an OT network 102. As used herein, telemetry data refers to any data collected by any device that monitors an aspect of an OT network 102. For example, telemetry data may include raw OT network traffic, processed OT network traffic, metadata describing raw and/or processed OT network traffic, and/or other data collected regarding the OT network.

### Executing Data Pipelines in Isolated Environments

The execution module 184 creates and/or manages a plurality of environments 102-106 that are isolated from each other. In some embodiments, the pipeline execution module 184 includes one or more services that execute on an OT network device. The execution module 184 causes execution of a set of one or more data pipelines 112-122 in each environment 102-106. In the illustrated example, the data pipeline management system 110 executes two data pipelines 112-114 in environment 102, one data pipeline 116 in environment 104, and three data pipelines 118-122 in environment 106.

An isolated environment running on a computer system has restricted access to one or more resources of the computer system, such as processing, memory, storage, network, I/O devices, and/or other resources. The isolated environment's access to resources varies depending on the implementation of the isolated environment. A program executing in an isolated environment of a computer system will not consume or access resources of the computer system that are not available to the isolated environment. Example techniques for creating an isolated environment include sandboxing, containerization, virtual machines, and/or other techniques. A program (e.g., an application, process, service, and/or other programs) executing in an isolated environment is isolated from other programs executing on the computer system, thereby mitigating failures and/or vulnerabilities caused by the program. For example, an error in a particular isolated environment 106 is less likely to affect the execution of data pipelines 112-116 executing in other environments 102-104, execution of applications 150-152, 156-158 executing in other environments 102-104, or the integrity, availability, and/or confidentiality of data associated with other environments 102-104.

Security and data privacy may be increased in the data pipeline management system 110 and the OT network 102 by the use of isolated environments 102-106. For example, access to data generated and/or stored in each environment 102-106 may be limited to programs belonging to the environment 102-106. For example, telemetry data and/or other data ingested by a data pipeline 112-122 may include sensitive and/or identifiable information with respect to the OT network, devices in the OT network, and/or a corresponding organization. The sensitive and/or identifiable information may provide visibility that is critical to understanding and mitigating a security threat on the OT network. However, outside of the OT network, the data may be used for reconnaissance and/or malicious purposes. A vulnerability in a particular isolated environment 106 is less likely to affect the execution of data pipelines 112-116 executing in other environments 102-104, execution of applications 150-152, 156-158 executing in other environments 102-104, or the integrity, availability, and/or confidentiality of data associated with other environments 102-104.

In some embodiments, each environment 102-106 has access to memory and/or storage resources to store a data store 170-174 that includes data handled by the data pipelines 112-122 belonging to the respective environment 102-106. For example, a data store 170-174 can include at least a portion of raw data and/or processed data handled by the corresponding data pipelines 112-122 in the corresponding environment 102-106, such as but not limited to raw data as ingested from the data source 132-140, transformed data, and/or metadata associated with the processing of the data. In some embodiments, a data store 170-174 belonging to a particular environment 102-106 is only accessible to the particular environment 102-106. For example, the data store 170 of environment 102 may include data handled by data pipelines 112-114 and may be accessible only within environment 102. The data store 172 of environment 104 may include data handled by data pipeline 116 and may be accessible only within environment 104. The data store 174 of environment 106 may include data handled by data pipelines 118-122 and may be accessible only within environment 106.

In some embodiments, the data pipeline management system 110 executes a set of one or more data management applications 150-160 in each environment 102-106. Data management applications 150-160 executing in one environment 102-106 are isolated from applications and/or data belonging to another environment 102-106. Applications within environment 102 (e.g., search application instance 150 and visualization application instance 156) can access data store 170, while applications outside environment 102 cannot access data store 170. Applications within environment 104 (e.g., search application instance 152 and visualization application instance 158) can access data store 172, while applications outside environment 104 cannot access data store 172. Applications within environment 106 (e.g., search application instance 154 and visualization application instance 160) can the data store 174, while applications outside environment 106 cannot access data store 174.

In some embodiments, the data pipeline management system 110 executes one or more search application instances 150-154 in one or more environments 102-106. As used herein, with respect to a program, the term “instance” refers to a particular copy of the program executing on a particular computer. A search application instance 150 executing in environment 102 may search the data store 170 of environment 102. A search application instance 152 executing in environment 104 may search the data store 172 of environment 104. A search application instance 154 executing in environment 106 may search the data store 174 of environment 106.

As an alternative or addition, the data pipeline management system 110 may execute one or more visualization application instances 156-160 in one or more environments 102-106. A visualization application instance 156 executing in environment 102 may provide a user interface for manipulating and/or visualizing data in the data store 170 of environment 102. A visualization application instance 158 executing in environment 104 may provide a user interface for manipulating and/or visualizing data in the data store 172 of environment 104. A visualization application instance 160 executing in environment 106 may provide a user interface for manipulating and/or visualizing data in the data store 174 of environment 106.

In some embodiments, the data management application/s 150-160 executed by the data pipeline management system 110 includes one or more data pipeline applications. A data pipeline application is a data management application that executes one or more data pipelines 112-122. For example, a data pipeline 112-122 may be implemented as a set of instructions and/or processes that are executed by a data pipeline application. In some embodiments, the data pipeline management system 110 executes the data pipelines 112-122 by executing one or more data pipeline application instances in each environment 102-106, where the data pipeline application instances execute the data pipelines 112-122. When data pipeline application instances are executed in an environment 102-106, each data pipeline application instance may execute one or multiple data pipelines 112-122.

In some embodiments, the data pipeline management system 110 executes an Elasticsearch-Logstash-Kibana (ELK) cluster in each environment 102-106. An ELK cluster is a set of connected node/server instances within the Amazon OpenSearch Service/Elasticsearch framework. For example, the search application instances 150-154 may include one or more Elasticsearch instances. Elasticsearch is a search server/engine in the Amazon OpenSearch Service framework. As another example, the visualization application instances 156-160 may include one or more Kibana instances. Kibana is a visualization server/tool in the Amazon OpenSearch Service framework. In some embodiments, the data pipelines 112-122 include one or more Logstash instances. Logstash is a data pipeline server/engine in the Amazon OpenSearch Service framework. For example, a data pipeline management system 110 may execute one or more Logstash instances in an environment 102-106. When an environment 102-106 executes multiple Logstash pipelines, each Logstash instance of the environment 102-106 may execute one or multiple Logstash pipelines.

### Pipeline Design and Template Library

In some embodiments, the data pipeline management system 110 includes a pipeline design module 182. The pipeline design module 182 enables an end user to design data pipelines using a template library 186 that includes pipeline component templates. The pipeline component templates allow an end user to create data pipelines in an OT network without specialized technical expertise. For example, a pipeline component template may include code that handles an underlying data pipeline framework, specific OT data sources, specific OT destinations, specific OT network protocols, and/or other specialized technical knowledge.

In some embodiments, the template library 186 includes at least one extract template. An extract template includes code that, when executed, obtains data from a data source. As an alternative and/or addition, the template library 186 includes at least one transform template. A transform template includes code that, when executed, converts and/or analyzes data. As an alternative and/or addition, the template library 186 includes at least one load template. A load template includes code that, when executed, writes and/or sends data to a destination.

In some embodiments, the pipeline component templates are modular. For example, when an end user may design a data pipeline by selecting an extract template to obtain data from an OT network appliance, selecting a transform template to convert the data to conform with a selected OT protocol required by a historian device, and selecting a load template to send the converted data to the historian device.

In order to generate a data pipeline from one or more pipeline template components, a user may need to supply one or more attribute values for one or more attributes that are required to allow a data pipeline to function. For example, the user may supply an attribute value for the address of a data source and/or destination, username and/or credential information, port information, and/or other attribute values. The pipeline design UI 182 may accept user input comprising the attribute values for the selected set of one or more pipeline component templates.

### Prioritizing Data Pipelines

The data pipeline management system 110 may prioritize the execution of data pipelines 112-122 and/or data management applications 150-160. The pipeline execution module 184 may implement a priority scheme by controlling access to one or more resources of the data pipeline management system 110, such as processing, memory, storage, network, I/O devices, and/or other resources. In some embodiments, the pipeline execution module 184 manages priority at an environment level, such as by controlling access to one or more resources of the data pipeline management system 110. For example, the pipeline execution module 184 may use a hypervisor to allocate resources to each environment 102-106. Alternatively and/or in addition, the pipeline execution module 184 may implement an active monitoring scheme to prioritize one or more aspects of the execution of one or more data pipelines 112-122 and/or data management applications 150-160, such as but not limited to orchestration, load balancing, and the like. The prioritization of data pipelines 112-122, data management applications 150-160, and/or environments 102-106 protects the integrity and availability of the respective data and/or improves the performance of data management functionality.

In an example priority scheme, the data pipeline management system 110 may assign data pipelines 112-122 of the same priority to the same environment 102-106. For example, the pipeline execution module 184 may execute a set of data pipelines 112-114 with a high priority in environment 102, a set of data pipelines 116 with a medium priority in environment 104, and a set of data pipelines 118-122 with a low priority in environment 106. The data pipeline management system 110 may prioritize execution of the data pipelines 112-122 by prioritizing environment 102 first, environment 104 second, and environment 106 third. The prioritization of environment 102 first has the effect of giving high priority to a set of data pipelines 112-114 and/or data management applications 150, 156 executing in environment 102. The prioritization of environment 104 second has the effect of giving medium priority to a set of data pipelines 116 and/or data management applications 152, 158 executing in environment 104. The prioritization of environment 104 third has the effect of giving low priority to a set of data pipelines 118-122 and/or data management applications 154, 160 executing in environment 106.

In some embodiments, a set of high priority data pipelines 112-114 in environment 102 includes one or more data pipelines that are generated based on pipeline component templates designed by an authorized party. As an alternative and/or addition, a set of medium priority data pipelines 116 in environment 104 includes one or more data pipelines that are generated based on pipeline component templates designed by an approved third party. As an alternative and/or addition, a set of low priority data pipelines 116 in environment 106 includes one or more data pipelines that are generated based on pipeline component templates designed by one or more end users of the data pipeline management system 110. Examples of an authorized party include an organization that designed and/or manufactures an OT network device on which a data pipeline management system 110 is deployed. Examples of an approved third party include partners of a designer and/or manufacturer of the data pipeline management system 110, a designer and/or manufacturer of one or more data sources 132-140, an OT protocol organization and/or expert, and/or other approved third parties. Examples of end users may include organizations that purchased and/or use the OT network device.

### Example Operational Technology (OT) Network

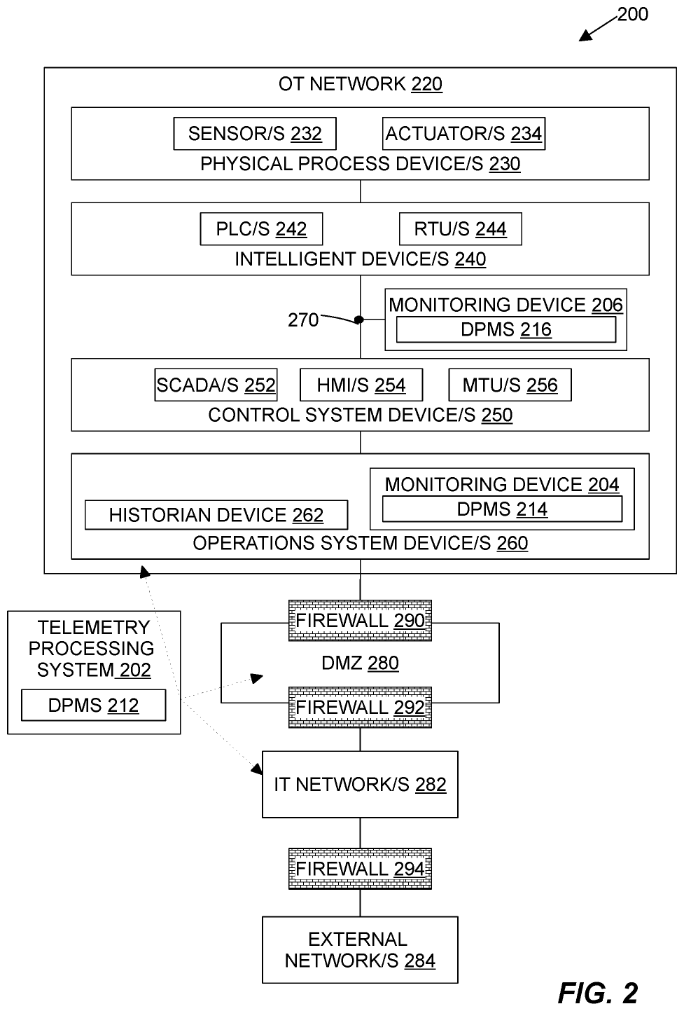

FIG. 2 illustrates a computer network that includes one or more hardware devices deployed in an operational technology (OT) network in an example embodiment. A computer network 200 includes an OT network 220. The OT network 220 may include one or more physical process devices 230. The physical process device/s 230 include one or more instruments or other physical components directly involved in carrying out an industrial process or other physical processes. For example, the physical process device/s 230 may include one or more sensors 232, actuators 234, other physical process devices, and/or any combination thereof. A sensor 232 is a component that converts a physical phenomenon into a digital and/or analog signal, such as to detect and/or monitor changes in an environment. The digital signal may be transmitted to another device in the OT network 220. Examples of sensors 232 include temperature sensors, humidity sensors, pressure sensors, light sensors, flow sensors, touch sensors, proximity sensors, location sensors, accelerometers, gyroscopes, gas sensors, infrared sensors, and/or any other device that can acquire data in the environment in which the device is deployed. An actuator 234 is a component that is responsible for moving and/or controlling a physical mechanism in the environment in which the actuator 234 is deployed. An actuator 234 may act in response to control signals transmitted from another device in the OT network 220. Examples of actuators 234 include switches, valves, motors, piezo generators, and/or any other device that controls a physical mechanism.

The OT network 220 may include one or more intelligent devices 240. An intelligent device 240 includes one or more microcontrollers or other processors that are configured to receive data from and/or send control commands to one or more physical process devices 230. For example, the intelligent device/s 240 may include one or more programmable logic controllers (PLCs) 242, remote terminal units (RTUs 244), other intelligent devices, and/or any combination thereof. An intelligent device 240 may be directly connected to one or more physical process devices 230.

The OT network 220 may include one or more control system devices 250. A control system device 250 communicates with lower-level control devices, such as intelligent devices 240, to monitor and/or control processes and operations in the OT network 220. For example, the control system device/s 250 may include one or more supervisory control and data acquisition (SCADA) systems 252, human-machine interfaces (HMIs) 254, master terminal units (MTUs) 256, alarm and alert systems, control room workstations, other control system devices, and/or any combination thereof.

The OT network 220 may include one or more operations system devices 260. For example, an operations system device 260 may support site operations within the OT network 220. As another example, an operations system device 260 may handle communications from the OT network 220 to a device in another network belonging to the same organization. Examples of operations system devices 260 include database servers, application servers, file servers, reliability assurance systems, scheduling and reporting systems, engineering workstations, and the like. The operation system device/s 260 may include one or more historian devices 262. A historian device 262 aggregates and records production and process data from various sources in the OT network 220, such as but not limited to one or more sensors 232, actuators 234, PLCs 242, RTUs 244, SCADAs 252, and/or MTUs 256.

In FIG. 2, network connectivity is illustrated in a simplified manner between physical process devices 230 and intelligent devices 240, between intelligent devices 240 and control system devices 250, and between control system devices 250 and operations system devices 260. However, network communications may be enabled within any devices within the OT networks 220.

The OT network 220 may be isolated from the Internet and/or one or more IT network/s 282 of the same organization. For example, a firewall 290 may be positioned at the perimeter of the OT network 220. A firewall is a network security device that monitors incoming and outgoing network traffic. The firewall 290 may permit and/or block data packets based on a set of security rules. The firewall 290 may protect the OT network 220 from unwanted network traffic, such as malicious code, intrusion attempts, and/or other unwanted traffic.

The computer network 200 may include a demilitarized zone (DMZ) 280. A DMZ is a sub-network placed between two networks with different trust levels, such as an OT network and an enterprise network, to add an additional layer of security. A DMZ may be implemented using firewalls, proxy servers, intrusion detection systems (IDSs), intrusion prevention systems (IPSs), and/or other systems. For example, a first firewall 290 may be positioned between the DMZ 280 and an organization's OT network 220, and a second firewall 292 may be positioned between the DMZ 280 and networks that are external to the OT network 220, such as the organization's separate OT network/s, the organization's IT network/s 292, and/or external networks 284 that are external to the organization. In some embodiments, a firewall 294 is positioned between an organization's other networks, such as an IT network 282, and external network/s 284.

### Example Monitoring Device

In some embodiments, a data pipeline management system 214-216 is deployed on one or more monitoring devices 204-206. A monitoring device 204-206 is configured to collect, inspect, and/or otherwise process network traffic in the OT network 220. In some embodiments, a monitoring device 204-206 may process OT network traffic to generate telemetry data that is further processed by another component of the computer network 200. The telemetry data may include raw OT network traffic, processed OT network traffic, metadata describing raw and/or processed OT network traffic, and/or other data collected regarding the OT network.

Some specific examples of telemetry data include a source device IP address, a source device MAC address, a source communication port, a source device identifier, a source device manufacturer, a source device hardware and/or firmware version, a source device type, a destination device IP address, a destination device MAC address, a destination communication port, a destination device identifier, a destination device manufacturer, a destination device hardware and/or firmware version, a destination device type, a monitoring device IP address, a monitoring device MAC address, a monitoring device communication port, a monitoring device identifier, a monitoring device manufacturer, a monitoring device hardware and/or firmware version, a monitoring device type, one or more timestamps, a communication protocol, one or more OT reading values (e.g., value/s obtained by a sensor 232), one or more OT control commands issued, a communication type, information describing a detected security threat (e.g., type, severity, identifier, etc.), other data included in raw OT network traffic, other data generated by the monitoring device 204-206, and/or other data collected by the monitoring device 204-206.

A monitoring device 204-206 may gain access to the network traffic by being connected to the OT network 220. A monitoring device 204-206 may be deployed at any location in the OT network 220 to collect network traffic passing through the respective location. For example, a monitoring device 206 may be connected to equipment 270 in the OT network 220 that provides the monitoring device 206 access to network traffic. The equipment 270 may be an active device or a passive network device. In some embodiments, the equipment 270 includes a switch that includes a switched port analyzer (SPAN) port. The monitoring device 206 is coupled to the SPAN port such that the switch sends a mirrored copy of network traffic passing through the switch to the monitoring device 206. As an alternative or addition, the equipment 270 may be a network tap. A network tap is a system that monitors events on a local network. For example, a network tap may send all passing traffic to the monitoring device 206. In some embodiments, a monitoring device 204 is deployed in OT network 220 as an operations system device 260. A monitoring device 204 that is deployed as an operations system device 260 may also be connected to equipment such as a SPAN port of a switch, a network tap, or other equipment that provides the monitoring device 204 access to network traffic.

A monitoring device 204-206 may process the network traffic to generate telemetry data. For example, a monitoring device 204-206 may perform deep packet inspection of communications sent in accordance with various industrial protocols to extract telemetry data related to the operation of the OT network 220. Deep packet inspection evaluates packets transmitted through an inspection point in a network, including packet header and packet data. Deep packet inspection may identify non-compliance to a communication protocol and unauthorized communications within a network. The monitoring device/s 204-206 may provide the extracted telemetry data to a telemetry processing system 202.

In some embodiments, the monitoring device/s 204-206 handle telemetry data by executing one or more data pipelines (e.g., data pipelines 112-122). For example, a data pipeline management system 214-216 deployed on a monitoring device 204-206 may execute one or more data pipelines to ingest network traffic originating from one or more data sources (e.g., data sources 132-140) in the OT network (e.g., OT network 102).

### Example Telemetry Processing System

In some embodiments, a data pipeline management system 212 is deployed on one or more telemetry processing systems 202. A telemetry processing system 202 processes telemetry data originating in an OT network 220. The telemetry processing system 202 can process the telemetry data for a variety of purposes, such as monitoring, reporting, management, compliance, and/or other purposes. In some embodiments, the telemetry processing system 202 processes the telemetry data to detect vulnerabilities, anomalies, intrusions, or other security threats on the OT network 220. The telemetry processing system 202 may be deployed in various network configurations with respect to the computer network 200 without departing from the spirit or scope of the embodiments described herein. For example, a telemetry processing system 202 may be deployed as a physical device or a virtual device on-premises, such as within an OT network 220 of an organization, within the DMZ 280 associated with the OT network 220, within an IT network 282 of the organization, or at another location on-premises operated by the organization. As an alternative or addition, a telemetry processing system 202 may be virtually deployed on behalf of the organization in a cloud computing environment.

In some embodiments, the telemetry processing system 202 receives telemetry data collected by one or more monitoring devices 204-206 deployed in the OT network 220. The telemetry data may include raw OT network traffic collected by the monitoring device/s 204-206. As an alternative or addition, the telemetry data may include processed OT network traffic and/or metadata generated by the monitoring device/s 204-206. The telemetry processing system 202 may also generate telemetry data. As an alternative or addition, the telemetry data may include other OT data received from one or more other OT data sources (e.g. data sources 132-140), such as firewall logs, OT system logs, IT system logs, OT network information, properties for one or more devices in the OT network, historian data, and/or other data.

In some embodiments, the telemetry processing system 202 handles telemetry data by executing one or more data pipelines (e.g. data pipelines 112-122). For example, a data pipeline management system 212 deployed on a telemetry processing system 202 may execute one or more data pipelines to receive and/or otherwise process telemetry data originating from one or more data sources (e.g., data sources 132-140) via one or more monitoring devices 204-206.

### Example Processes

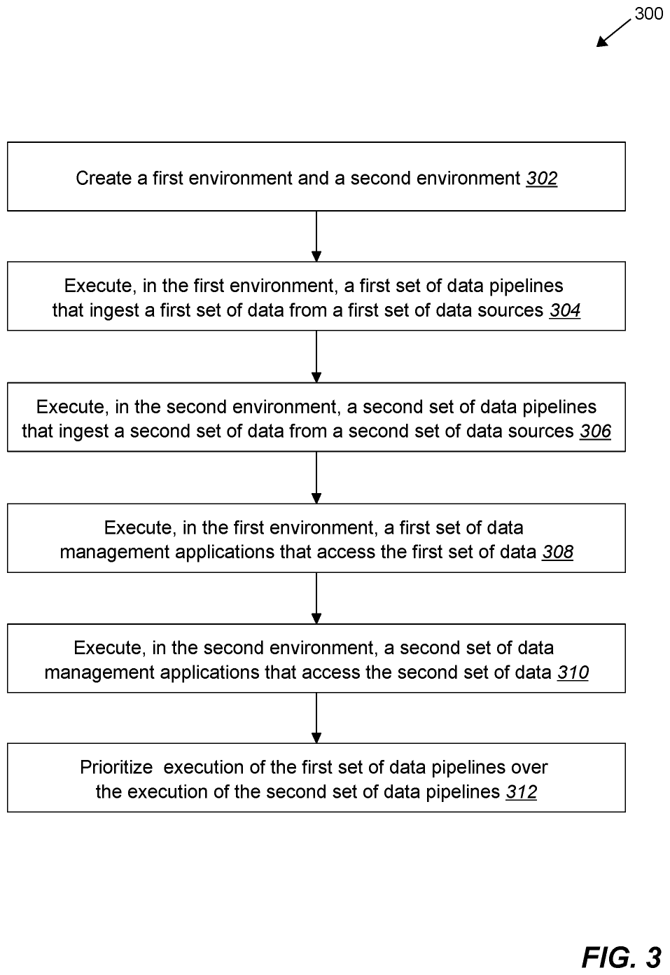

FIG. 3 is a flow diagram of a process for data pipeline management in an example embodiment. Process 300 may be performed by one or more computing devices and/or processes thereof. For example, one or more blocks of process 300 may be performed by a computer system (e.g., computer system 500). In some embodiments, one or more blocks of process 300 are performed by a data pipeline management system (e.g., data pipeline management system 110) and/or a hardware device (e.g., telemetry processing system 202, monitoring devices 204-206) that implements a data pipeline management system. Process 300 will be described with respect to the computer system of FIG. 1, but is not limited to performance by such.

At block 302, the data pipeline management system 110 creates a first environment 102 and a second environment 106 that are isolated. The first environment 102 does not have access to data generated and/or stored outside of the first environment 102, and the second environment 106 does not have access to data generated and/or stored outside of the second environment 106.

At block 304, the data pipeline management system 110 executes, in the first environment 102, a first set of data pipelines 112-114 that ingest a first set of data from a first set of data sources deployed in an operational technology (OT) network 102. For example, the first set of data pipelines may extract, transform, load, or perform other operations on the first set of data. In examples, at least a portion of the first set of data is stored in a data store 170 belonging to the first environment 102.

At block 306, the data pipeline management system 110 executes, in the second environment 106, a second set of data pipelines that ingest a second set of data from a second set of data sources deployed in the OT network. In examples, at least a portion of the second set of data is stored in a data store 174 belonging to the second environment 106. In various examples, the first set of data sources and the second set of data sources may be the same, different, or overlapping.

At block 308, the data pipeline management system 110 executes, in the first environment 102, a first set of data management applications 150, 156 that access the first set of data 170. For example. For example, the first set of data management applications 150, 156 may include a search application instance 150 and a visualization application instance 156 that access the data store 170 belonging to the first environment 102. The first set of data management applications 150, 156 of the first environment 102 are isolated from the second set of data 174 of the second environment 106.

At block 310, the data pipeline management system 110 executes, in the second environment 106, a second set of data management applications 154, 160 that access the second set of data 174. For example. For example, the second set of data management applications 154, 160 may include a search application instance 154 and a visualization application instance 160 that access the data store 174 belonging to the second environment 106. The second set of data management applications 154, 160 of the second environment 106 are isolated from the first set of data 170 of the second environment 102.

At block 312, the data pipeline management system 110 prioritizes execution of the first set of data pipelines 112-114 over execution of the second set of data pipelines 118-122.

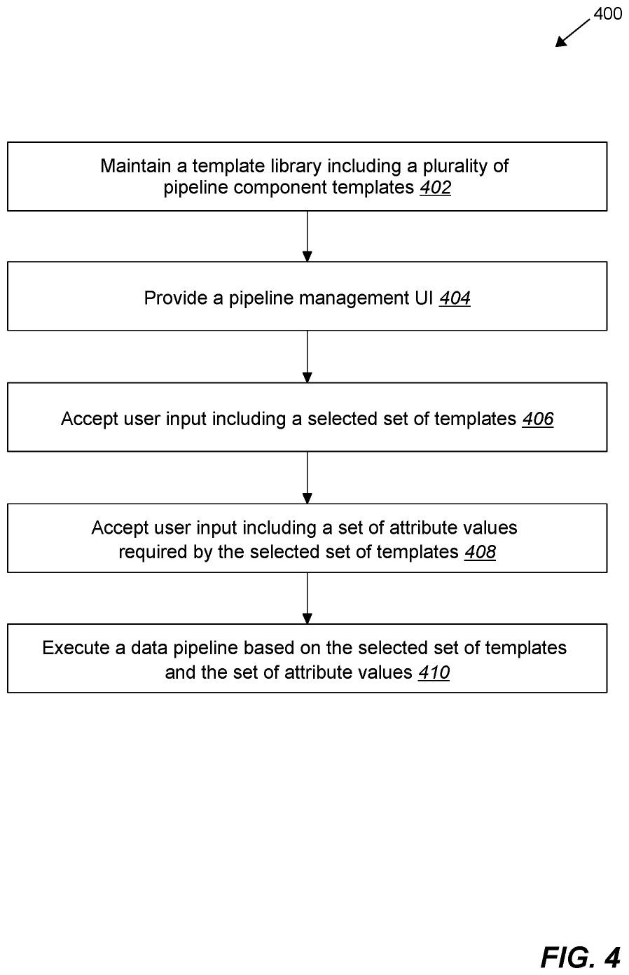

FIG. 4 is a flow diagram of a process for facilitating user creation of a pipeline using templates in an example embodiment. Process 400 may be performed by one or more computing devices and/or processes thereof. For example, one or more blocks of process 400 may be performed by a computer system (e.g., computer system 500). In some embodiments, one or more blocks of process 400 are performed by a data pipeline management system (e.g., data pipeline management system 110) and/or a hardware device (e.g., monitoring devices 204-206, telemetry processing system 202) that implements a data pipeline management system. Process 400 will be described with respect to the computer system of FIG. 1, but is not limited to performance by such.

At block 402, the data pipeline management system 110 maintains a template library including a plurality of pipeline component templates. In some embodiments, the plurality of pipeline component templates includes at least one extract template, at least one transform template, and at least one load template. At block 404, the data pipeline management system 110 provides a pipeline creation UI 192 to a client device 190. At block 406, the data pipeline management system 110 accepts user input including a selected set of templates. At block 408, the data pipeline management system 110 accepts user input including a set of attribute values required by the selected set of templates. At block 410, the data pipeline management system 110 executes a data pipeline based on the selected set of templates and the set of attribute values.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field-programmable gate arrays (FPGAs) that are persistently programmed to perform the techniques. Alternatively and/or in addition, the one or more special-purpose computing devices may include one or more general-purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, and/or any other device that incorporates hard-wired or program logic to implement the techniques.

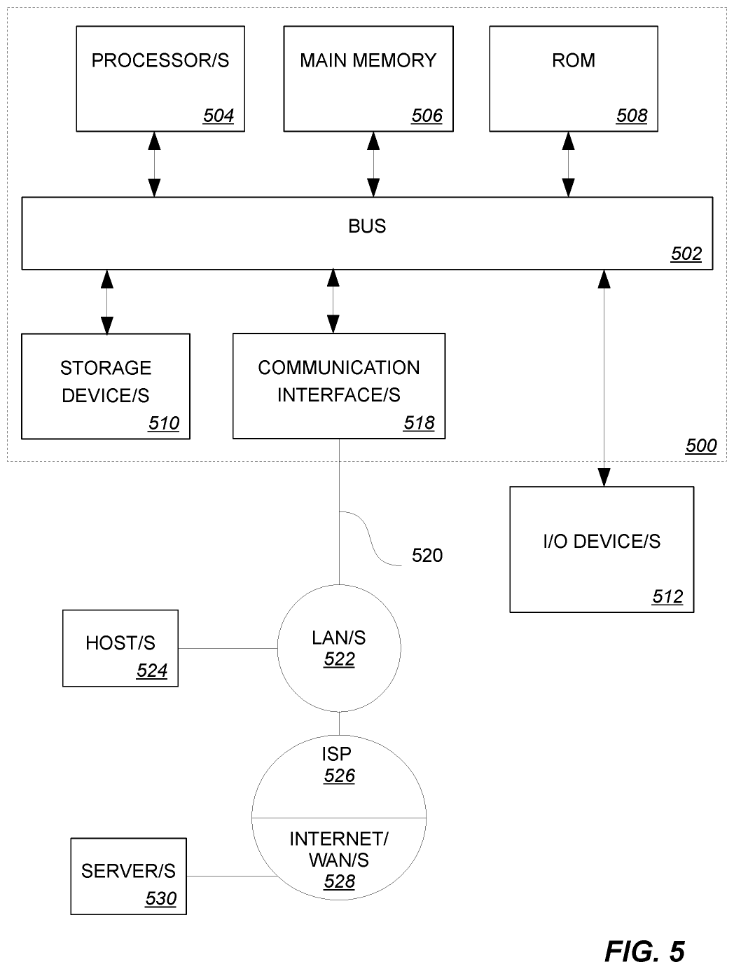

FIG. 5 is a block diagram that illustrates a computer system 500 upon which an embodiment may be implemented. The computer system 500 includes a bus 502 or other communication mechanism for communicating information, and one or more hardware processors 504 coupled with bus 502 for processing information, such as computer instructions and data. The hardware processor/s 504 may include one or more general-purpose microprocessors, graphical processing units (GPUs), coprocessors, central processing units (CPUs), and/or other hardware processing units.

The computer system 500 also includes one or more units of main memory 506 coupled to the bus 502, such as random-access memory (RAM) or other dynamic storage, for storing information and instructions to be executed by the processor/s 504. Main memory 506 may also be used for storing temporary variables or other intermediate information during execution of instructions to be executed by the processor/s 504. Such instructions, when stored in non-transitory storage media accessible to the processor/s 504, turn the computer system 500 into a special-purpose machine that is customized to perform the operations specified in the instructions. In some embodiments, main memory 506 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

The computer system 500 may further include one or more units of read-only memory (ROM) 508 or other static storage coupled to the bus 502 for storing information and instructions for the processor/s 504 that are either always static or static in normal operation but reprogrammable. For example, the ROM 508 may store firmware for the computer system 500. The ROM 508 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 510, such as a magnetic disk or optical disk, is provided and coupled to the bus 502 for storing information and/or instructions. The storage device/s 510 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid-state drives, flash memory, optical disks, one or more forms of non-volatile random-access memory (NVRAM), and/or other non-volatile storage media.

The computer system 500 may be coupled via the bus 502 to one or more input/output (I/O) devices 512. For example, the I/O device/s 512 may include one or more displays for displaying information to a computer user, such as a cathode ray tube (CRT) display, a Liquid Crystal Display (LCD) display, a Light-Emitting Diode (LED) display, a projector, and/or any other type of display.

The I/O device/s 512 may also include one or more input devices, such as an alphanumeric keyboard and/or any other keypad device. The one or more input devices may also include one or more cursor control devices, such as a mouse, a trackball, a touch input device, or cursor direction keys for communicating direction information and command selections to the processor 504 and for controlling cursor movement on another I/O device (e.g. a display). A cursor control device typically has at degrees of freedom in two or more axes, (e.g. a first axis x, a second axis y, and optionally one or more additional axes z), that allows the device to specify positions in a plane. In some embodiments, the one or more I/O device/s 512 may include a device with combined I/O functionality, such as a touch-enabled display.

Other I/O device/s 512 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with the processor/s 504 over the bus 502.

The computer system 500 may implement the techniques described herein using customized hard-wired logic, one or more ASICs or FPGAs, firmware, and/or program logic which, in combination with the computer system causes or programs, causes computer system 500 to be a special-purpose machine. According to one embodiment, the techniques herein are performed by the computer system 500 in response to the processor/s 504 executing one or more sequences of one or more instructions contained in main memory 506. Such instructions may be read into main memory 506 from another storage medium, such as the one or more storage device/s 510. Execution of the sequences of instructions contained in main memory 506 causes the processor/s 504 to perform the process steps described herein. In alternative embodiments, hard-wired circuitry may be used in place of or in combination with software instructions.

The computer system 500 also includes one or more communication interfaces 518 coupled to the bus 502. The communication interface/s 518 provide two-way data communication over one or more physical or wireless network links 520 that are connected to a local network 522 and/or a wide area network (WAN), such as the Internet. For example, the communication interface/s 518 may include an integrated services digital network (ISDN) card, cable modem, satellite modem, or a modem to provide a data communication connection to a corresponding type of telephone line. Alternatively and/or in addition, the communication interface/s 518 may include one or more of: a local area network (LAN) device that provides a data communication connection to a compatible local network 522; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network access a wide area network (WAN, such as the Internet 528); and other networking devices that establish a communication channel between the computer system 500 and one or more LANs 522 and/or WANs.

The network link/s 520 typically provides data communication through one or more networks to other data devices. For example, the network link/s 520 may provide a connection through one or more local area networks 522 (LANs) to one or more host computers 524 or to data equipment operated by an Internet Service Provider (ISP) 526. The ISP 526 provides connectivity to one or more wide area networks 528, such as the Internet. The LAN/s 522 and WAN/s 528 use electrical, electromagnetic, or optical signals that carry digital data streams. The signals through the various networks and the signals on the network link/s 520 and through the communication interface/s 518 are example forms of transmission media, or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire and fiber optics, including traces and/or other physical electrically conductive components that comprise the bus 502. Transmission media can also take the form of acoustic or light waves, such as those generated during radio-wave and infra-red data communications.

Various forms of media may be involved in carrying one or more sequences of one or more instructions to the processor 504 for execution. For example, the instructions may initially be carried on a magnetic disk or solid-state drive of a remote computer. The remote computer can load the instructions into its main memory 506 and send the instructions over a telecommunications line using a modem. A modem local to the computer system 500 can receive the data on the telephone line and use an infra-red transmitter to convert the data to an infra-red signal. An infra-red detector can receive the data carried in the infra-red signal and appropriate circuitry can place the data on the bus 502. The bus 502 carries the data to main memory 506, from which the processor 504 retrieves and executes the instructions. The instructions received by main memory 506 may optionally be stored on the storage device 510 either before or after execution by the processor 504.

The computer system 500 can send messages and receive data, including program code, through the network(s), the network link 520, and the communication interface/s 518. In the Internet example, one or more servers 530 may transmit signals corresponding to data or instructions requested for an application program executed by the computer system 500 through the Internet 528, ISP 526, local network 522 and a communication interface 518. The received signals may include instructions and/or information for execution and/or processing by the processor/s 504. The processor/s 504 may execute and/or process the instructions and/or information upon receiving the signals by accessing main memory 506, or at a later time by storing them and then accessing them from the storage device/s 510.

### OTHER ASPECTS OF DISCLOSURE

The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments are described with reference to specific details that may vary from implementation to implementation. Nevertheless, it will be understood that various modifications may be made without departing from the spirit and scope of the invention. The examples set forth above are provided to those of ordinary skill in the art as a complete disclosure and description of how to make and use the embodiments, and are not intended to limit the scope of what the inventor/inventors regard as their invention. Modifications of the above-described modes for carrying out the methods and systems herein disclosed that are obvious to persons of skill in the art are intended to be within the scope of the present disclosure and the following claims. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. An operational technology network device comprising:
one or more processors;
at least one memory coupled to the one or more processors and storing instructions which, when executed by the one or more processors, cause the one or more processors to:
create, on the operational technology network device, a first environment and a second environment that are isolated;
execute, in the first environment, a first set of data pipelines that ingest a first set of data from a first set of data sources deployed in an operational technology (OT) network;
execute, in the second environment, a second set of data pipelines that ingest a second set of data from a second set of data sources deployed in the OT network;
execute, in the first environment, a first set of data management applications that access the first set of data and are isolated from the second set of data;
execute, in the second environment, a second set of data management applications that access the second set of data and are isolated from the first set of data; and
prioritize execution of the first set of data pipelines over execution of the second set of data pipelines.

2. The operational technology network device of claim 1, wherein the instructions, when executed by the one or more processors, cause the one or more processors to:
prioritize execution of the first set of data management applications over execution of the second set of data management applications.

3. The operational technology network device of claim 1, wherein the first set of data pipelines is generated based on pipeline component templates designed by an authorized party.

4. The operational technology network device of claim 1, wherein the second set of data pipelines is generated based on pipeline component templates designed by an end user of the operational technology network device.

5. The operational technology network device of claim 1, wherein the instructions, when executed by the one or more processors, cause the one or more processors to:
execute a third environment that is isolated from the first environment and the second environment;
execute, in the third environment, a third set of data pipelines that ingest a third set of data from a third set of data sources; and
execute, in the third environment, a third set of data management applications that access the third set of data and are isolated from the first set of data and the second set of data;
wherein execution of the third set of data pipelines is prioritized after execution of the first set of data pipelines and before execution of the second set of data pipelines.

6. The operational technology network device of claim 5, wherein the third set of data pipelines is generated based on pipeline component templates designed by an approved third party.

7. The operational technology network device of claim 1:
wherein the first set of data management applications comprises a search application instance for searching the first set of data; and
wherein the second set of data management applications comprises a search application instance for searching the second set of data.

8. The operational technology network device of claim 1:
wherein the first set of data management applications comprises a visualization application instance for manipulating and presenting the first set of data; and
wherein the second set of data management applications comprises a visualization application instance for manipulating and presenting the second set of data.

9. The operational technology network device of claim 1:
wherein executing the first set of data pipelines includes executing, in the first environment, at least one data pipeline application instance that executes the first set of data pipelines; and
wherein executing the second set of data pipelines includes executing, in the second environment, at least one data pipeline application instance that executes the second set of data pipelines.

10. The operational technology network device of claim 9:
wherein the at least one data pipeline application instance that executes the first set of data pipelines includes at least one Logstash instance executing in the first environment;
wherein the at least one data pipeline application instance that executes the second set of data pipelines includes at least one Logstash instance executing in the second environment; and
wherein the first set of data management applications and the second set of data management applications each comprise an Elasticsearch instance and a Kibana instance.

11. The operational technology network device of claim 1, wherein the instructions, when executed by the one or more processors, cause the one or more processors to:
maintain a template library comprising a plurality of pipeline component templates;
provide a pipeline creation user interface (UI) to a client device;
accept user input including a selected set of pipeline component templates;
accept user input including a set of attribute values required by the selected set of pipeline component templates; and
execute a data pipeline based on the selected set of templates and the set of attribute values.

12. The operational technology network device of claim 11, wherein the plurality of pipeline component templates comprises at least one extract template, at least one transform template, and at least one load template.

13. A computer-readable medium storing instructions which, when executed by one or more processors, cause the one or more processors to:
create, on an operational technology network device, a first environment and a second environment that are isolated;
execute, in the first environment, a first set of data pipelines that ingest a first set of data from a first set of data sources deployed in an operational technology (OT) network;
execute, in the second environment, a second set of data pipelines that ingest a second set of data from a second set of data sources deployed in the OT network;
execute, in the first environment, a first set of data management applications that access the first set of data and are isolated from the second set of data;
execute, in the second environment, a second set of data management applications that access the second set of data and are isolated from the first set of data; and
prioritize execution of the first set of data pipelines over execution of the second set of data pipelines.

14. The computer-readable medium of claim 13, wherein the instructions, when executed by the one or more processors, cause the one or more processors to:
prioritize execution of the first set of data management applications over execution of the second set of data management applications.

15. The computer-readable medium of claim 13,
wherein the first set of data pipelines is generated based on pipeline component templates designed by an authorized party;
wherein the second set of data pipelines is generated based on pipeline component templates designed by an end user of the operational technology network device.

16. The computer-readable medium of claim 13, wherein the instructions, when executed by the one or more processors, cause the one or more processors to:
execute a third environment that is isolated from the first environment and the second environment;
execute, in the third environment, a third set of data pipelines that ingest a third set of data from a third set of data sources; and
execute, in the third environment, a third set of data management applications that access the third set of data and are isolated from the first set of data and the second set of data;
wherein execution of the third set of data pipelines is prioritized after execution of the first set of data pipelines and before execution of the second set of data pipelines.

17. The computer-readable medium of claim 13:
wherein the first set of data management applications comprises a search application instance for searching the first set of data; and
wherein the second set of data management applications comprises a search application instance for searching the second set of data.

18. The computer-readable medium of claim 13:
wherein the first set of data management applications comprises a visualization application instance for manipulating and presenting the first set of data; and
wherein the second set of data management applications comprises a visualization application instance for manipulating and presenting the second set of data.

19. The computer-readable medium of claim 13, wherein the instructions, when executed by the one or more processors, cause the one or more processors to:
maintain a template library comprising a plurality of pipeline component templates;
provide a pipeline creation user interface (UI) to a client device;
accept user input including a selected set of pipeline component templates;
accept user input including a set of attribute values required by the selected set of pipeline component templates; and
execute a data pipeline based on the selected set of templates and the set of attribute values.

20. A method comprising:
creating, on an operational technology network device, a first environment and a second environment that are isolated;
executing, in the first environment, a first set of data pipelines that ingest a first set of data from a first set of data sources deployed in an operational technology (OT) network;
executing, in the second environment, a second set of data pipelines that ingest a second set of data from a second set of data sources deployed in the OT network;
executing, in the first environment, a first set of data management applications that access the first set of data and are isolated from the second set of data;
executing, in the second environment, a second set of data management applications that access the second set of data and are isolated from the first set of data; and
prioritizing execution of the first set of data pipelines over execution of the second set of data pipelines.
wherein the method is performed by a hardware device comprising one or more processors.
